(19) United States
(12) Patent Application Publication
(10) Pub. No.: US 2006/0254058 A1
(43) Pub. Date: Nov. 16, 2006

(54) MANUAL FRUIT SLICER WITH INTERCHANGEABLE CUTTING AND CORING DISKS

(76) Inventor: Ming-Shih Chang, Taipei (TW)

Correspondence Address: Ming-Shih, Chang, P.O.Box 166-13, Taipei, 115, TW

(21) Appl. No.: 11/127,076

(22) Filed: May 12, 2005

(51) Int. Cl. A21C 15/04

(52) U.S. Cl. 30/114

(57) ABSTRACT

The present invention is aimed to provide a manual fruit slicer with interchangeable cutting and coring base. It has the practical functions as replacement of disks, reverted said edges onto the base, and a plurality of said edges can be received in the base. In use, a manual fruit slicer comprises a base, and disks. A hollowed annular sleeve is protruded out from the base around its center with two jug-ears extended out from both of its ends. A disk is designed as an annular edge frame disposed inside the hollowed annular sleeve. It is characterized by L type grooves formed through the upper or lower section being adapted to the handles protruded out from the outer wall of the disk to fix in place. The handles are also designed for a user's grip.

### FIELD OF THE INVENTION

The present invention is related to a manual fruit slicer with interchangeable cutting and coring disks, as a manual instrument used to cut off core of fruit in addition to cut the pulp into slices simultaneously.

### BACKGROUND OF THE INVENTION

With Reference to FIG. 14, a perspective view of a conventional manual fruit slicer is illustrated. A conventional manual fruit slicer 9 includes an annular slicing base 91 with a hollowed coring circlet 93 at its center and straight edges 92 disposed axially between the base 91 and the coring circlet 93. In that, said edges 92 and coring circlet 93 are combined by welding, fusing or other means, and then put the edges-circlet semi-finished instrument into a mold, being engaged with an injection molded annular base 91 to form a manual fruit slicer 9 as a whole one. The edges 92 are secured to the annular base 91.

With reference to FIG. 15, a schematic view of a conventional manual fruit slicer in use is shown. As the user holds both two raised jug-ears with two hands, and then places the fruit below the slicer 9, after pressing down the slicer 9 over the fruit, the axially distributed edges and the coring circlet at its center divides the fruit into pieces and crops out the core of the fruit.

According to the FIGS. 14 and 15, it is understood that the conventional manual fruit slicer in use causes the defects as following:
1. Different kinds of fruits such as pear, apple, citrus, tomato and pineapple have different sizes of cores. And different users are used to divide the fruits into pieces in bulky lumps, small slices, or cubes as desired. Conventional manual slicer has the fixed edges and the fixed diameter of the coring circlet, the sliced pulps and cropped out cores always have been cut in the same shape. Because the base has never been changed into a different size. A big fruit may be cut less off its core, and a small fruit can be divided more of its fruit flesh into a deserted core portion.
2. A conventional manual fruit slicer has the edges exposed outward, while the edges being touched by the user erroneously leads to possible injuries occurred to the users' touching fingers. Even the slicer is placed or stacked with the plates and bowls together, the edges are easy to clash against the plate or bowl inflicted the edges abraded, broken or rust.

### SUMMARY OF THE INVENTION

Accordingly, the present invention is aimed to provide a manual fruit slicer with interchangeable cutting and coring disks comprising a base and a disk, the base has a hollowed annular sleeve protruded out around its center, two laterally extended out jug-ears are formed at both ends, a plurality of edges shaped as a disk disposed in the hollowed annular sleeve, wherein an L-type groove formed on a wall of the hollowed annular sleeve, the groove is served for receiving a handle projected out from outer wall of the disk of the annular sleeve, the handle is led into said L-type groove in place.

Said a manual fruit slicer with interchangeable cutting and coring disks is characterized in that both of the top and bottom ends of the hollowed annular sleeve have L-type grooves, and another two disks being placed in the base by ways of both the top and bottom ends of the hollowed annular sleeve, a handle projected out from the outer wall of the disk being led into the L-type groove in place.

Said a manual fruit slicer with interchangeable cutting and coring disks, in that, an annular flange bulged out from the centerline of the inner wall, the inner wall being divided into upper and lower sections for receiving upper and lower inscribed polygonal circles of edges put in.

Said a manual fruit slicer with interchangeable cutting and coring disks, in that, said L type groove being formed through a wall of the hollowed annular sleeve, an opening of the L type groove is shaped in opened-up mode, the handle is passed through the L-type groove for manual operation.

Said a manual fruit slicer with interchangeable cutting and coring disks, in that, said L-type groove has an entry portion formed along (not through) a wall of the hollowed annular sleeve, but the end portion of the L-type groove formed through the wall of the hollowed annular sleeve, the handle formed as a shortened positioned stud being led into the L-type groove in place.

Point against the aforesaid problems, the present invention provides a manual fruit slicer with interchangeable cutting and coring disks comprising a base and a disk, the base has a hollowed annular sleeve projected out from the base around its center, two laterally extended out jug-ears are formed at both ends, a disk formed as an inner circle disposed in the hollowed annular sleeve, wherein an outer circle of the hollowed annular sleeve has an L-type groove and a concaved groove separated from the L-type groove, a handle being bulged out from the outer wall of a disk and a positioned stud separated from the handle, the handle being led into said concaved groove in place, the positioned stud being led into said L-type groove in place.

Said a manual fruit slicer with interchangeable cutting and coring disks characterized in that both of the top and bottom ends of the seat have L-type grooves; an annular flange bulged out from the centerline of the inner wall, dividing the inner wall into upper and lower sections for receiving upper and lower disks put in, the handles being bulged out from the outer walls of the disks of the hollowed annular sleeve can be led into the L type grooves in places.

Point against the aforesaid problems, the present invention provides an interchangeable cutting and coring disk adapted to the aforesaid manual fruit slicer comprising a disk, a plurality of straight edges being disposed in the inner circle wherein a small handle being bulged out from the outer wall of the disk.

Said an interchangeable cutting and coring disk characterized in that an edged coring circlet disposed inside the disk at its center, and a plurality of straight edges are disposed around an edged coring circlet.

Said an interchangeable cutting and coring disk characterized in that a plurality of straight edges are arranged in sequence at intersection alternately.

The merits can be achieved by the present invention in practice as following:

The present invention a manual fruit slicer with interchangeable cutting and coring disks has a separable base and a disk. In use, the disks can be changed as desired. While combining a base and a disk to form a manual fruit slicer, a force is exerted to divide the fruit into slices more easily, as one of the different disks is chosen and combined to form a set of useable straight edges with a central edged coring circlet at any time, the fruits can be processed through and divided into bulky lumps, small slices, pieces, or cubes with the different cores of fruits cropped out as desired. After using, a disk is detachable and can be combined to the base in an opposite direction, thus achieves a secured decoration of the reversed-edges to avoid straight edges from directly exposing outward.

Secondly, handles projected out from the outer wall of a disk are suitable for both two hands of the user to hold and operate, when changing and combining the chosen one from the two or more different disks, it can be used to lower the possibility of injuries as the users' fingers to touch the edges unintentionally.

Thirdly, the base of a manual fruit slicer has the capacity for receiving one or two or more disks put in, the user may choose one from them to use. When the chosen one is not in use, the disk can be combined to the base in an opposite direction, the reversed-edges is set up for avoiding edges from exposing outward.

Fourthly, a disk can be used to cut and core a small fruit or soft fruit without combining to a base in advance. In use the user can hold a handle bulged out from the outer wall of a disk to operate.

### DETAILED DESCRIPTION OF THE INVENTION

The description is described according to the appended drawings hereinafter.

### First Embodiment

With reference to FIG. 1, an exploded perspective view of the first embodiment of the present invention is illustrated. Manual fruit slicer 10 comprises a base 1, a disk 2 or 3.

Said base 1 has a hollowed annular sleeve 11 protruded out from the base at its center with two laterally extended jug-ears at both ends, two L-type grooves 14 are formed on each side beside the opening of the hollowed annular sleeve 11, two L type grooves 14 are shaped in the opposite direction and distributed in symmetry with each other. At this place, L type grooves 14 are formed through a wall of the annular sleeve 11 beside the opening, and the entry portion of the L type groove is shaped in opened up mode.

Said disks are grouped into two kinds of edges. Illustrated on the left side of the FIG. 1, a disk 2 comprises an annular edge frame 21 (i.e. an inner circle) with a central hollowed circlet 23, and a plurality of straight edges 22 (it is exemplified as eight edges) distributed in symmetry between the annular edge frame 21 and the central hollowed circlet 23. Illustrated on the right side of the FIG. 1, a disk 3 comprises an annular edge frame 31 and a plurality of straight edges 32 (it is shown as four edges) distributed in symmetry in the annular edge frame 31.

Secondly, pairs of handles 24, 33 are bulged out from the outer wall of the disks 2,3 respectively are corresponding to the L type grooves 14. The pairs of handles 24,33 are formed as prolonged positioned studs. Pairs of handles 24, 33 are not only designed for the user to grip easily but also characterized by its function of buckling with L type groove in place conveniently. The length of the handles 24,33 is longer than the breadth of a wall of the annular edge frame 21, but the breadth of the handles 24, 33 is not restricted to the user for such a wall breadth consideration. After the base 1 is combined with the disks 2 or 3, pairs of handles 24,33 are passed through and extended out from the L-type grooves 14.

Refer to FIG. 2. As a disk 2 being used to combine with a base 1, the user holds a pair of handles 24 bulged out from an outer wall of the disk 2 with two hands, and then vertically leads the handles 24 into L type grooves 14 which are formed through both sides of the hollowed annular sleeve 11, and then horizontally rotates the handles 24 along the L-type grooves 14 at an angle to buckle with the L-type groove 14 in place. Thus the disk 2 can be secured to the base 1 swiftly. As the user is to detach a disk 2 from a base 1, only operating in the opposite direction, the disk 2 can be separated from the base 1 swiftly. In practice the user holds handles 24,33 respectively with one's own hands. The disks 2,3 can be operated and rotated easily. Being avoided both of hands from possible injuries due to the edges 22,32 installed inside the disks 2 or 3. It is easy to operate under safe and convenient condition.

### Second Embodiment

With reference to FIG. 3, an exploded perspective view of the second embodiment of the present invention is shown. A manual fruit slicer 10 comprises a base 1 and upper, lower disks 2,3. After combination, the assembled structure of the manual fruit slicer 10 is shown as the FIG. 4.

The second embodiment is different from the first embodiment. In the second embodiment, such as an annular flange 13 bulged out along the centerline of the inner wall of the hollowed annular sleeve 11. Thus the inner wall of sleeve 11 is divided into upper and lower sections. Both upper and lower sections have opening, both sides of the upper and lower sections beside the openings have top end, and L type grooves 14 are formed through the top ends in the opposite direction in symmetry.

Said disks 2,3 are illustrated in FIG. 1. As a disk 2 being put into the upper section of the hollowed annular sleeve 11, it has a pair of handles 24 bulged out from the outer wall of the disk 2, which is vertically led into the L type groove 14 and then being horizontally rotated to buckle with the L type groove 14 in place. Thus a disk 2 is fixed to the upper section of the hollowed annular sleeve 11 swiftly as the FIG. 5 is illustrated. And a disk 3 has a pair of handles 33 bulged out from the outer wall of itself to buckle with the L type grooves 14 formed through the lower section of the hollowed annular sleeve 11.

Because an annular flange 13 is secured between the upper and lower disks 2,3, so the upper and lower disks will not be in contact with each other, the straight edges 22,32 of the disks 2,3 being exposed inward not outward. Thus the disks will not lead to possible injuries of the users, it keeps a preferrable secure effect. When the user has to choose one of the disks 2, and 3, the disks 2, 3 are able to detach from the hollowed annular sleeve 11, and then chooses one of the disks 2,3, then reverts the chosen one being led into the hollowed annular sleeve 11. Since a pair of handles 24 or 33 are buckled with the L type grooves 14 in places, the straight edges of the disks can be exposed outward to slice the pulp of the fruits into pieces.

### Third Embodiment

With reference to FIG. 6, an exploded perspective view of the third embodiment of the present invention is shown. A manual fruit slicer 10 comprises a base 1 and disks 2,3. An assembled view of the manual fruit slicer is shown as FIG. 7.

In FIGS. 6 and 3, there have the same base 1 for adding components. And a hollowed annular sleeve 11 is protruded out from the base around the center with two laterally extended out jug-ears 12 at both ends. An annular flange 13 bulged out along the centerline of the inner wall of the hollowed annular sleeve 11. Thus the inner wall of sleeve 11 is divided into upper and lower sections. Both upper and lower sections have opening, both sides of the upper and lower sections beside the openings have top end. But in FIG. 6 an L type groove 14 and a concaved groove 15 separated from the L type groove are formed on each top end. In which, each pair of two L type grooves are formed in the opposite direction and distributed in symmetry. But each pair of concaved grooves 15 are corresponded to each other and distributed in symmetry. In the third embodiment the L type groove is shaped as a closed hoop type not opened-up which is different from the first and second embodiments.

The structure of said disks 2,3 is virtually identical to the aforesaid embodiments in use. At least two positioned studs 25,34 protruded out from the outer wall of annular edge frame 21,31 are corresponding to the two L type grooves 14 and distributed in symmetry. But in FIG. 6 the handles 24,33 protruded out from the outer wall of annular edge frame are only suitable for the user's grip not for buckling with the L type grooves. After the user holds the handles 24, or 33 led into the concaved grooves 15 and then rotates the disks 2, or 3 by handles 24, or 33, finally, the positioned studs 25,34 are led into the L type grooves 14 to rotate at a degree, to buckle with the L type grooves 14 in places. In the third embodiment, the positioned studs 25, 34 are adapted to buckle with the L type groove 14 is not designed for the user's grip by hands. A cross section view of the third embodiment of the present invention is illustrated as FIG. 8.

The third embodiment is illustrated a hollowed annular sleeve being adapted to a disk 2 or 3, but the present invention also can be practiced by a hollowed annular sleeve being adapted to only one of the disks 2 or 3 (not shown). Though it is not illustrated in the drawings, but the spirit of the only one disk still implied in the scope of this embodiment.

### Fourth Embodiment

With reference to FIG. 9, a perspective view of the fourth embodiment of the present invention is illustrated. A manual fruit slicer 10 comprises a base 1 and disks 2,3. An assembly view of the fourth embodiment is shown as FIG. 10.

The fourth embodiment is different from the first embodiment. Such as an L type groove 14 is not passed through the wall of the base 1. A depth of the entry portion of the L type groove 14 is only equal to a half of the breadth of the wall. But the depth of the end portion of the L type groove is nil, it means the L type groove has the same depth as the breadth of the wall. And positioned studs 25,34 are shorter than the handles 24,33 of first embodiment of the present invention. In other words, the positioned studs 25,34 is identical to the shorten handles 24,33, which is not suitable for user's grip. The positioned studs 25,34 can be led into the L type groove 14 to fix is not like the handles 24,33 being extended out from the annular sleeve 11.

The fourth embodiment is different from the third embodiment. In the fourth embodiment, a base 1 has no need to form a concaved groove 15 as the third embodiment is shown. Also in the fourth embodiment, disks 2,3 have no need to form handles 24,33 as the third embodiment is shown. In the fourth embodiment, hoop like L type grooves (not open-up) formed through an outer wall of the sleeve 11, positioned studs 25,34 projected out from the outer wall of the disks 2,3 are corresponding to the L type grooves 14. Because there are no handles, when the base 1 being combined with the disks 2,3, the user has to pay attention to lead the positioned studs 25,34, projected out from the outer wall of the idisks into the L type grooves 14 to rotate and fix. After assembly, the assembly view is shown as the FIG. 10.

In the fourth embodiment, the base 1 is combined with two disks 2,3. In use, a base 1 can be combined with a disk 2, or 3 individually. Therefore, these embodiments can be implied in the scope of the present invention.

FIGS. 11 to 13 are illustrated as an embodiment of the present invention. It is to provide a manual fruit slicer of the second embodiment for dividing an apple with core into slices. To elect a disk 2 with a central edged coring circlet 23, and a disk 3 is removed from lower section of a hollowed annular sleeve 11 in advance. And then move the edges of the disk 2 to face to the apple. Then presses down the edges to divide the apple into slices. After slicing, the divided apple is shown as the FIG. 12. At this time, the apple is cropped out the core and divided into pieces.

With reference to FIG. 13, a disk 3 without a central edged coring circlet 23 is applied to divide the small fruit or fruit without core portion, such as a citrus. Only through a pressing down action, the citrus can be divided into pieces.

Secondly, a disk is initially provided in the present invention. The whole body of the manual fruit slicer can be made of metal. Or the annular edge frame 21, 31 can be made through injection mold, the straight edges 22,32 and the coring circlet 23 are made of metal. Because a disk 2 or 3 is applied to cut a small fruit or fruit without core portion into pieces directly, there is no need to combine said disks to a base 1 in advance. The user only needs to hold the handles 24,33 by hands to operate it swiftly, so that a disk applied to divide the pulp of the fruit is implied in the scope of the present invention.

The present invention is described in details according to the appended drawings, it will be understood by those skilled in the art that many of these details may be varied without departing from the spirit and scope of the invention.

### BRIEF DESCRIPTION OF THE DRAWINGS

FIG. 1: an exploded perspective view of the first embodiment of the present invention;

FIG. 2: an assembly view of the first embodiment of the present invention;

FIG. 3: an exploded perspective view of the second embodiment of the present invention;

FIG. 4: an assembly view of the second embodiment of the present invention;

FIG. 5: a cross section view of the second embodiment of the present invention;

FIG. 6: an exploded perspective view of the third embodiment of the present invention;

FIG. 7: an assembly view of the third embodiment of the present invention;

FIG. 8: a sectional view of the third embodiment of the present invention;

FIG. 9: a shematic view of the present invention is applied to cut and core an apple;

FIG. 10: a schematic view of an apple is processed through a cutting and coring act;

FIG. 11: a schematic view of the present invention is applied to cut and core a citrus;

FIG. 12: a perspective view of a conventional manual fruit slicer; and

FIG. 13: a cross section view of a conventional manual fruit.

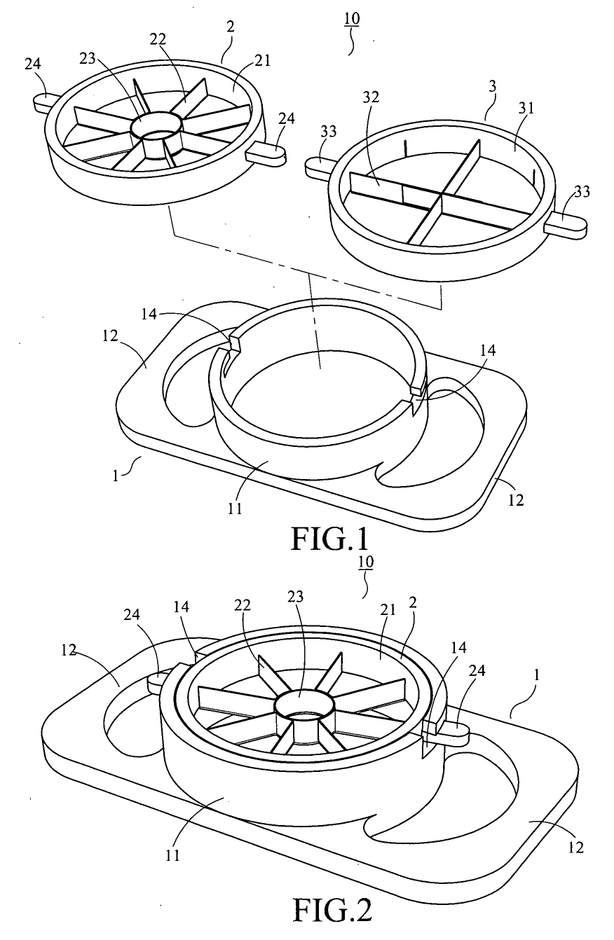

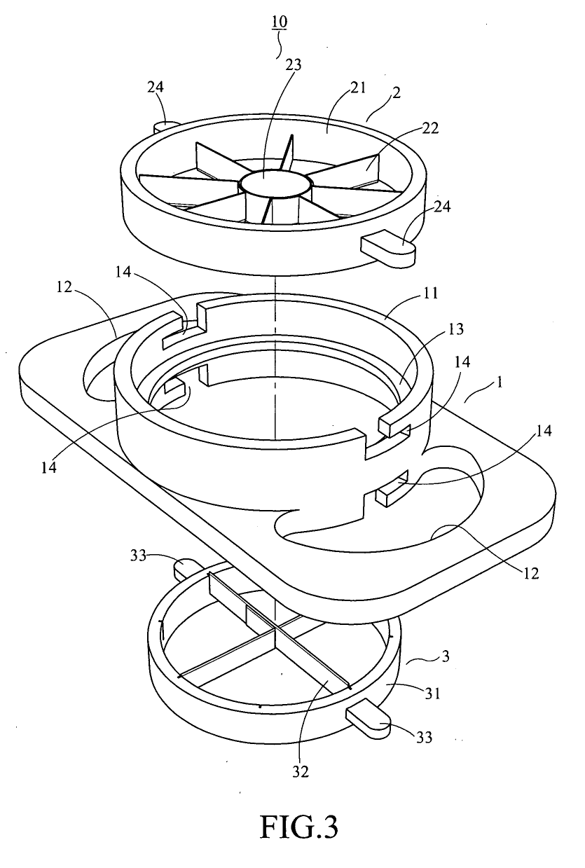

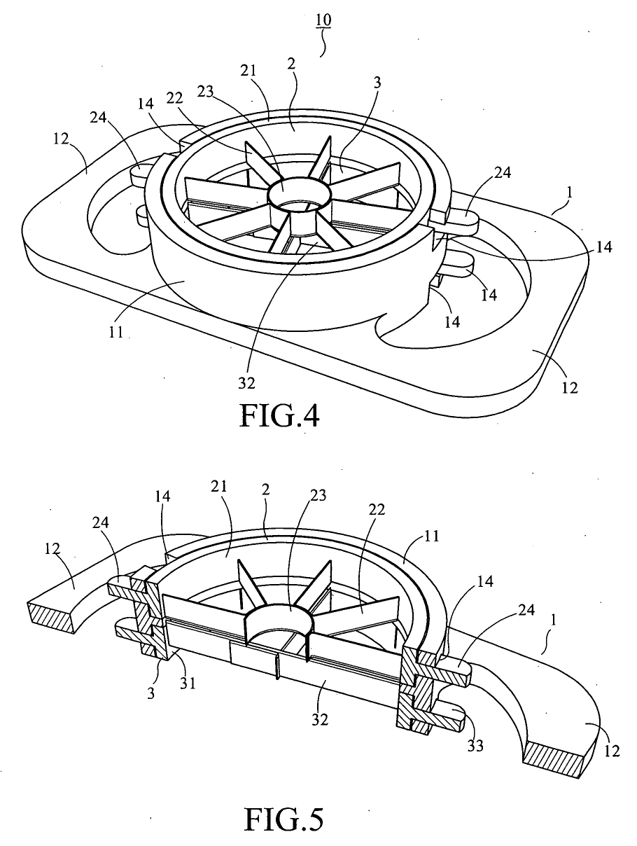

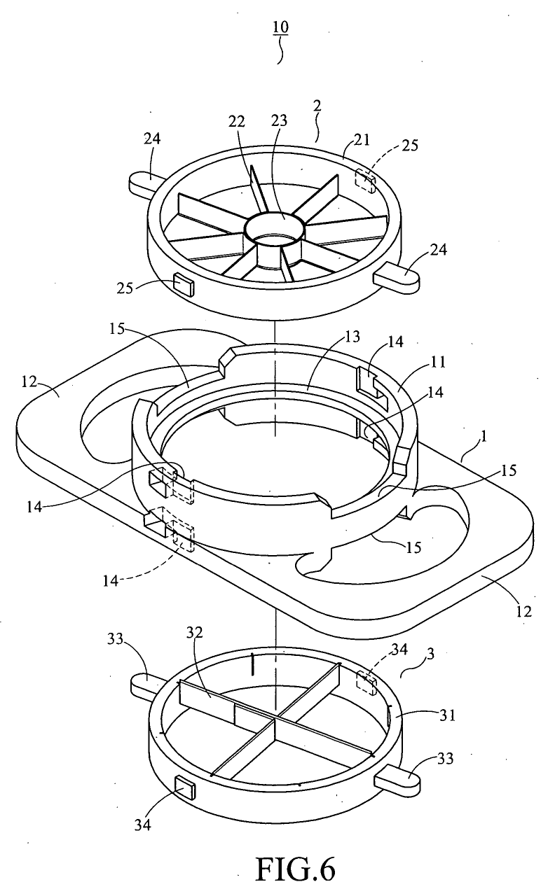

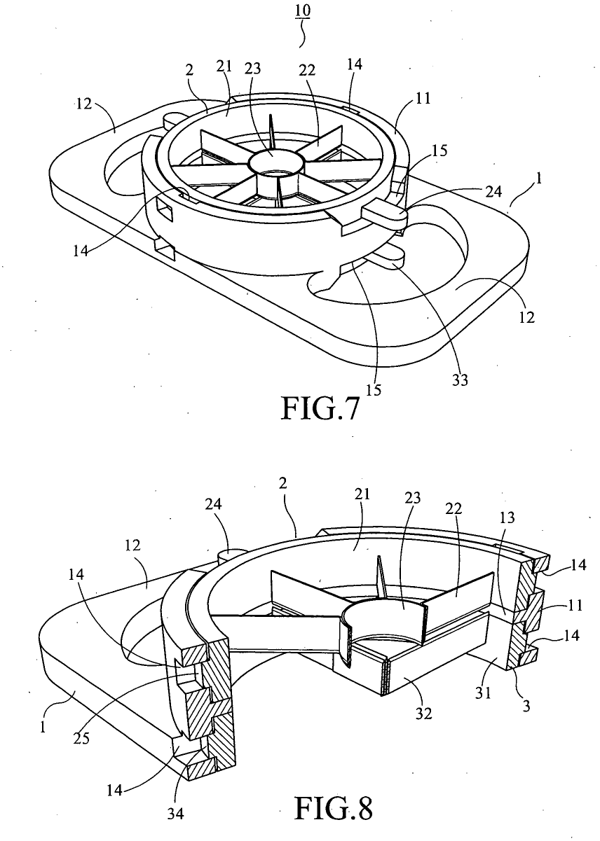

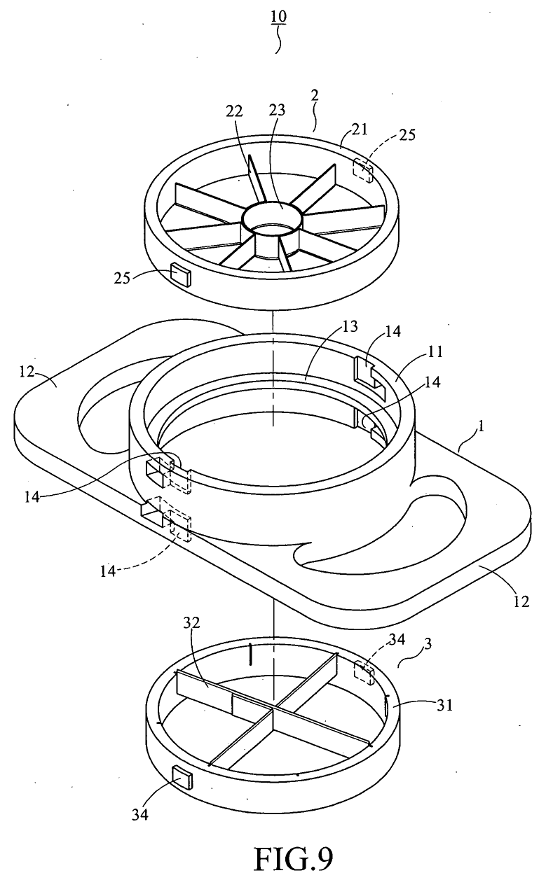

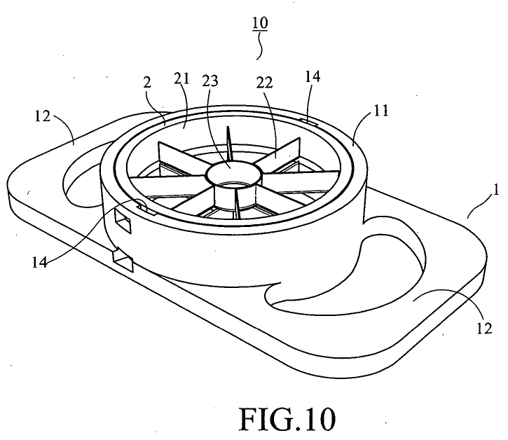

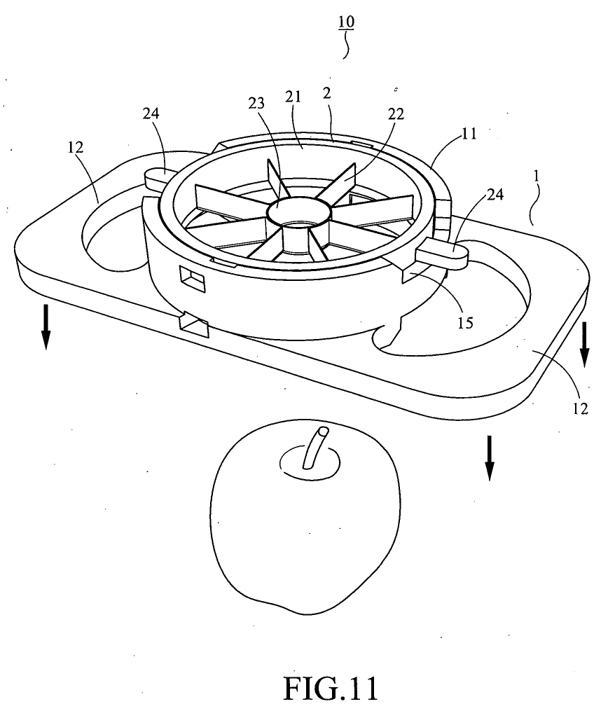

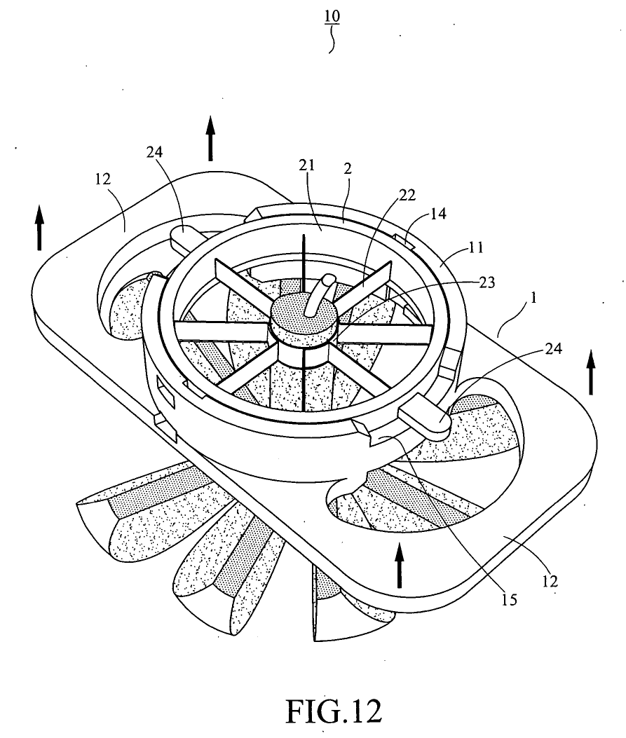

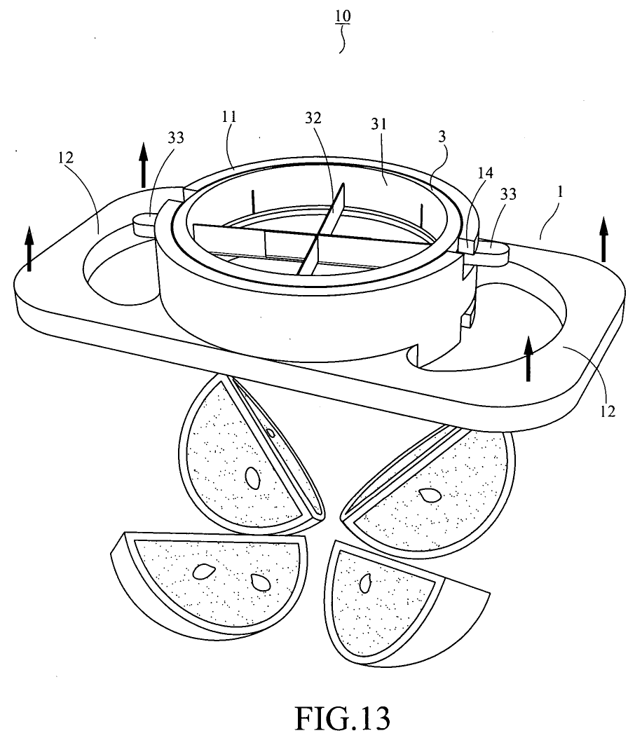

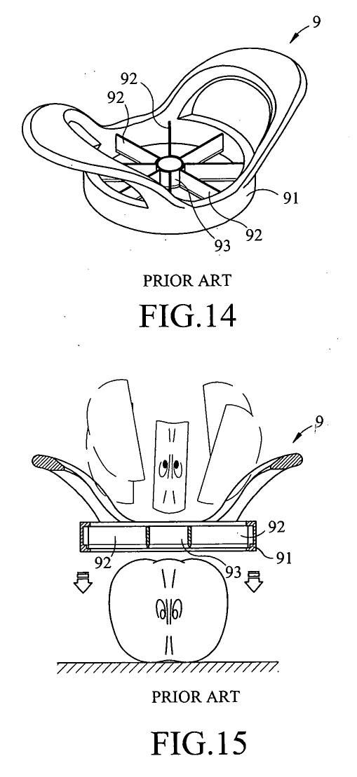

1. A manual fruit slicer with interchangeable cutting and coring disks comprising: a base and a disk, the base has a hollowed annular sleeve protruded out around its center with two laterally extended out jug-ears formed at both ends, the disks disposed in the hollowed annular sleeve, characterized in that L-type grooves formed through a wall of the hollowed annular sleeve, the grooves is served for receiving handles respectively which are projected out from outer wall of the annular sleeve, the handles are led into said L-type groove in place.

2. A manual fruit slicer with interchangeable cutting and coring disks according to claim 1, wherein both of the top and bottom portions of the hollowed annular sleeve have L-type grooves, and another two disks being placed in the base by ways of both the top and bottom portions of the hollowed annular sleeve, handles projected out from the outer wall of the disks are led into the L-type grooves in places.

3. A manual fruit slicer with interchangeable cutting and coring disks according to claim 2, wherein an annular flange bulged out from the centerline of the inner wall, the inner wall being divided into upper and lower sections for receiving upper and lower disks put in.

4. A manual fruit slicer with interchangeable cutting and coring disks according to claim 1, wherein said L type groove being formed through a wall of the hollowed annular sleeve, an opening of the L type groove is shaped in opened-up mode, the handle is passed through the L-type groove for manual operation.

5. A manual fruit slicer with interchangeable cutting and coring disks according to claim 2, wherein said L type groove being formed through a wall of the hollowed annular sleeve, an opening of the L type groove is shaped in opened-up mode, the handle is passed through the L-type groove for manual operation.

6. A manual fruit slicer with interchangeable cutting and coring disk according to claim 1, wherein said L-type groove has an entry portion formed along (not through) a wall of the hollowed annular sleeve, but the end portion of the L-type groove formed through the wall of the hollowed annular sleeve, the handle formed as a shortened positioned stud being led into the L-type groove in place.

7. A manual fruit slicer with interchangeable cutting and coring disk according to claim 2, wherein said L-type groove has an entry portion formed along (not through) a wall of the hollowed annular sleeve, but the end portion of the L-type groove formed through the wall of the hollowed annular sleeve, the handle formed as a shortened positioned stud being led into the L-type groove in place.

8. A manual fruit slicer with interchangeable cutting and coring disk comprising: a base and a disk, the base has a hollowed annular sleeve projected out from the base around its center with two laterally extended out jug-ears formed at both ends, a disk formed as an inner circle disposed in the hollowed annular sleeve characterized in that an outer circle of the hollowed annular sleeve has an L-type groove and a concaved groove separated from the L-type groove, a handle being bulged out from the outer wall of a disk and a positioned stud separated from the handle, the handle being led into said concaved groove in place, the positioned stud being led into said L-type groove in place.

9. A manual fruit slicer with interchangeable cutting and coring disks according to claim 8, wherein both of the top and bottom ends of the seat have L-type groove, an annular flange being bulged out from the centerline of the inner wall, the inner wall being divided into upper and lower sections for receiving upper and lower disks put in, the handles being bulged out from the outer walls disks of the hollowed annular sleeve can be led into the L type groove in place.

10. An interchangeable cutting and coring disk is designed to adapt to said manual fruit slicer comprising a disk, a plurality of straight edges being disposed in the inner circle characterized in that a small handle being bulged out from the outer wall of the disk.

11. An interchangeable cutting and coring grid according to claim 10, wherein an edged coring circlet disposed inside the disk at its center, and a plurality of straight edges are disposed around the coring circlet.

12. An interchangeable cutting and coring disk according to claim 10, wherein a plurality of straight edges are arranged in sequence at intersection alternately.
